(19) United States
(12) Patent Application Publication
(10) Pub. No.: US 2023/0243970 A1
(43) Pub. Date: Aug. 3, 2023

(54) Object Tracking Device and Method of Determining Moving and Stationary States of Object Using Lidar Sensor

(71) Applicants: Hyundai Motor Company, Seoul (KR); Kia Corporation, Seoul (KR)

(72) Inventors: En Sun Lee, Seoul (KR); Hyun Ju Kim, Yongin-si (KR)

(21) Appl. No.: 18/060,793

(22) Filed: Dec. 1, 2022

(30) Foreign Application Priority Data
Feb. 3, 2022 (KR) 10-2022-0014231

(51) Int. Cl. G01S 17/66; G01S 7/48; G01S 17/10; G01S 17/931

(52) U.S. Cl. CPC G01S 17/66; G01S 7/4808; G01S 17/10; G01S 17/931

(57) ABSTRACT

An embodiment method of determining moving and stationary states of an object using a lidar sensor includes determining a type of object after assigning a score to object information obtained through object tracking, the score based on a score table in which scores are set according to characteristics of a dynamic object and a static object, and determining that the object is in a stationary state when the object is determined to be the static object, and determining whether the object is in a moving state or in the stationary state based on object tracking information on the object when the object is determined to be the dynamic object.

### CROSS-REFERENCE TO RELATED APPLICATIONS

This application claims the benefit of Korean Patent Application No. 10-2022-0014231, filed on Feb. 3, 2022, which application is hereby incorporated herein by reference.

### TECHNICAL FIELD

Embodiments relate to an object tracking device and a method of determining moving and stationary states of an object using a lidar sensor.

### BACKGROUND

A lidar (LiDAR: Light Detecting And Ranging) sensor may irradiate a laser pulse onto an object, then measure the return time of the laser pulse reflected from the object present within a measurement range so as to sense information on the object, such as the distance to the object, and the direction and velocity of the object. Accordingly, an autonomous driving function may be supported by obtaining information on a surrounding object using a lidar sensor.

In a case in which information on an object recognized using a lidar sensor is inaccurate, the reliability of autonomous driving may be lowered. For this reason, research to improve the accuracy of object detection is continuing.

### SUMMARY

Accordingly, embodiments of the present invention provide an object tracking device and a method of determining moving and stationary states of an object using a lidar sensor that substantially obviate one or more problems due to limitations and disadvantages of the related art.

An embodiment of the present invention provides an object tracking device and a method of determining moving and stationary states of an object using a lidar sensor capable of determining moving and stationary states of an object.

Additional advantages, objects, and features of embodiments of the invention will be set forth in part in the description which follows and in part will become apparent to those having ordinary skill in the art upon examination of the following or may be learned from practice of the invention. The objectives and other advantages of embodiments of the invention may be realized and attained by the structure particularly pointed out in the written description and claims hereof as well as the appended drawings.

Embodiments of the invention provide a method of determining moving and stationary states of an object using a lidar sensor, the method including determining a type of object after assigning a score, based on a score table in which scores are set according to characteristics of a dynamic object and a static object, to object information obtained through object tracking, and determining that the object is in a stationary state when the object is determined to be a static object, and determining whether the object is in a moving state or in a stationary state based on object tracking information on the object when the object is determined to be a dynamic object.

The object information may include at least one of velocity information, shape information, heading information, and classification information of the object.

The score table may include an item for assigning a dynamic score and an item for assigning a static score.

The determining the type of object may include comparing the dynamic score and the static score given according to the score table with first reference values set for the dynamic score and the static score, respectively, determining a type of object using an object having the dynamic score or the static score, which is greater than the first reference value, and determining the type of object as an unknown object when both the dynamic score and the static score are smaller than the first reference value.

The determining the type of object may include, when both the dynamic score and the static score are greater than the first reference value, comparing the dynamic score and the static score given according to the score table with a second reference value greater than the first reference value, determining a type of object using an object having the dynamic score or the static score, which is greater than the second reference value, determining the type of object as an unknown object when both the dynamic score and the static score are smaller than the second reference value, and determining the type of object as an unknown object when both the dynamic score and the static score are greater than the second reference value.

The method may further include, when the object is determined to be a dynamic object, confirming the determination after repeating the determining the type of object according to the dynamic score and the static score a plurality of times.

When an object tracking time is less than or equal to a reference time, the object determined to be an unknown object may be treated as a static object, and, when the object tracking time is greater than the reference time, the result determined as an unknown object may be maintained.

The method may further include determining the type of object after comparing the type of object determined at the current time point with the type of object determined at the previous time point.

In another embodiment of the present invention, there is provided a computer-readable recording medium on which a program configured to implement a method of determining moving and stationary states of an object using a lidar sensor is recorded, the medium being configured to perform functions of determining a type of object after assigning a score, based on a score table in which scores are set according to characteristics of a dynamic object and a static object, to object information obtained through object tracking, and determining that the object is in a stationary state when the object is determined to be a static object, and determining whether the object is in a moving state or in a stationary state based on object tracking information on the object when the object is determined to be a dynamic object.

In another embodiment of the present invention, there is provided an object tracking device using a lidar sensor, the device including the lidar sensor, and a lidar signal processor configured to track an object using lidar data obtained by the lidar sensor, determine a type of object after assigning a score, based on a score table in which scores are set according to characteristics of a dynamic object and a static object, to object information obtained through object tracking, determine that the object is in a stationary state when the object is determined to be a static object, and determine whether the object is in a moving state or in a stationary state based on object tracking information on the object when the object is determined to be a dynamic object.

The object information may include at least one of velocity information, shape information, heading information, and classification information of the object.

The score table may include an item for assigning a dynamic score and an item for assigning a static score.

The lidar signal processor may compare the dynamic score and the static score given according to the score table with first reference values set for the dynamic score and the static score, respectively, determine a type of object using an object having the dynamic score or the static score, which is greater than the first reference value, and determine the type of object as an unknown object when both the dynamic score and the static score are smaller than the first reference value.

The lidar signal processor may, when both the dynamic score and the static score are greater than the first reference value, compare the dynamic score and the static score given according to the score table with a second reference value greater than the first reference value, determine a type of object using an object having the dynamic score or the static score, which is greater than the second reference value, determine the type of object as an unknown object when both the dynamic score and the static score are smaller than the second reference value, and determine the type of object as an unknown object when both the dynamic score and the static score are greater than the second reference value.

The lidar signal processor may, when the object is determined to be a dynamic object, confirm the determination after repeating the determining the type of object according to the dynamic score and the static score a plurality of times.

The lidar signal processor may, when an object tracking time is less than or equal to a reference time, treat the object determined to be an unknown object as a static object, and, when the object tracking time is greater than the reference time, maintain the result in which the object is determined to be an unknown object.

The lidar signal processor may compare the type of object determined at a current time point with the type of object determined at a previous time point so as to determine the type of object.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram of an object tracking device using a lidar sensor according to an embodiment;

FIG. 2 is a control flowchart of an object tracking device using a lidar sensor according to an embodiment;

FIG. 3 is a flowchart of a method of determining whether an object is in a moving state or in a stationary state according to an object tracking method using a lidar sensor in an embodiment;

FIG. 4 is a flowchart of a method of determining the type of an object in step S320 of FIG. 3;

FIG. 5 is a state diagram for explaining a method of finally determining the type of an object by using history information after determining the type of an object in FIG. 4;

FIG. 6 is a flowchart of a method of determining the state of an object in step S320 of FIG. 3; and

FIGS. 7 to 21 are diagrams for explaining each item included in the score table of Table 1.

### DETAILED DESCRIPTION OF ILLUSTRATIVE EMBODIMENTS

Hereinafter, embodiments of the present invention will be described in detail with reference to the accompanying drawings. The embodiments of the present invention may be modified into various forms, and the scope of the present invention should not be construed as being limited to the following embodiments. These embodiments are provided so that this disclosure will be thorough and complete, and will fully convey the scope of the disclosure to those skilled in the art.

In the following description of the embodiments, it will be understood that, when an element is referred to as being “on” or “under” another element, it can be “directly” on or under the other element, or can be “indirectly” disposed such that an intervening element is also present.

In addition, when expressed as “on” or “under”, the meaning of the downward direction as well as the upward direction based on one element may be included.

In addition, relative terms such as, for example, “first”, “second”, “on”/“upper”/“above”, and “beneath”/“lower”/“below”, used in the following description may be used to distinguish any one substance or element from another substance or element without requiring or containing any physical or logical relationship or sequence between these substances or elements.

Throughout the specification, when an element is referred to as “including” another element, this means that the element may include another element as well, without excluding other elements, unless specifically stated otherwise. In order to clearly illustrate the present invention, parts not related to the description are omitted, and similar parts are denoted by like reference numerals throughout the specification.

According to this embodiment, when detecting an object using a lidar (LiDAR: light detection and ranging) sensor, in an object tracking process, a final object is managed by fusing the result of a detected object and previous object information so as to select the shape, location, velocity, and heading of the final object, then all information is finally combined to thereby determine whether the object is in a moving state or in a stationary state. Accordingly, accurate heading information may be obtained even for an object that varies greatly in shape.

Hereinafter, a vehicle lidar system and an object detection method performed by the system according to an embodiment will be described with reference to the drawings.

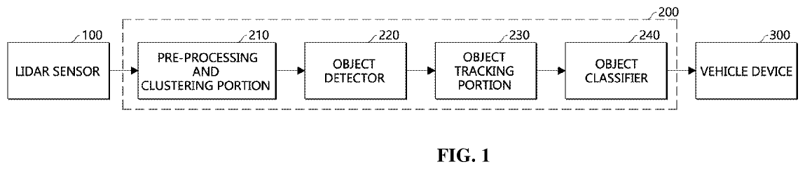

FIG. 1 is a block diagram of an object tracking device using a lidar sensor according to an embodiment.

Referring to FIG. 1, the object tracking device may include a lidar sensor 100, a lidar signal processor 200 configured to process data obtained from the lidar sensor 100 and output object tracking information, and a vehicle device 300 configured to control various functions of a vehicle according to object tracking information.

The lidar sensor 100 irradiates a laser pulse onto an object, then measures the return time of the laser pulse reflected from the object present within a measurement range so as to sense information on the object, such as the distance from the lidar sensor 100 to the object, and the direction, velocity, temperature, material distribution and concentration characteristics of the object. Here, the object may be another vehicle, person, or thing present outside the vehicle on which the lidar sensor 100 is mounted. However, the embodiment is not limited to a specific type of object. The lidar sensor 100 may output lidar point data including a plurality of points for a single object.

The lidar signal processor 200 may receive lidar point data so as to recognize an object, track the recognized object, and classify the type of object. The lidar signal processor 200 may include a pre-processing and clustering portion 210, an object detector 220, an object tracking portion 230, and an object classifier 240.

The pre-processing and clustering portion 210 may pre-process the lidar point data received from the lidar sensor 100 into a processable form and then group the same. The pre-processing and clustering portion 210 may pre-process the lidar point data by removing ground points. In addition, the pre-processing and clustering portion 210 may perform pre-processing in which the lidar point data is converted into a form available on a reference coordinate system according to the angle of the position at which the lidar sensor 100 is mounted, and a point having a low intensity or reflectance is removed by being filtered based on intensity or confidence information on the lidar point data. In addition, since there is an area covered by the body of a host vehicle depending on the mounting position and viewing angle of the lidar sensor 100, the pre-processing and clustering portion 210 may remove data reflected by the body of the host vehicle by using the reference coordinate system. The pre-processing of lidar point data is for refining valid data, and thus some or all of the processing may be omitted or other processing may be added. The pre-processing and clustering portion 210 may group the pre-processed lidar point data into meaningful units according to a predetermined rule. Because the lidar point data includes information such as location information, the pre-processing and clustering portion 210 may group a plurality of points into meaningful shape units and output the same to the object detector 220.

The object detector 220 may generate a contour using the grouped points and determine the shape of the object based on the generated contour. The object detector 220 may generate a shape box suitable for the shape of the object based on the determined shape of the object.

The object tracking portion 230 generates a track box configured to track an object based on the shape box generated by the object detector 220, and tracks an object by selecting a track box associated with the object being tracked. The object tracking portion 230 may obtain attribute information such as heading of a track box by signal processing lidar point data obtained from each of the plurality of lidar sensors 100. The object tracking portion 230 may perform signal processing to obtain such attribute information in every cycle. A cycle of obtaining attribute information is called a step, and information recognized in each step may be preserved as history information, and generally, information of up to 5 steps is preserved as history information. After selecting the shape, location, velocity, and heading of the object, the object tracking portion 230 finally synthesizes all information so as to determine whether the object is in a moving state or in a stationary state.

The object classifier 240 classifies the object into a pedestrian, a guardrail, a car or the like according to the detected object information, and outputs the same to the vehicle device 300.

The vehicle device 300 may receive a lidar track from the lidar signal processor 200 and apply the same to control a driving function.

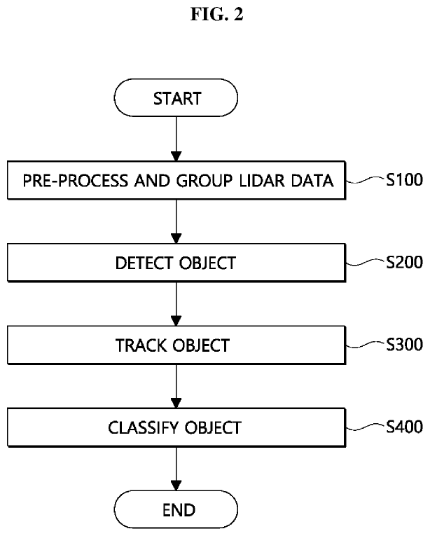

FIG. 2 is a control flowchart of an object tracking device using a lidar sensor according to an embodiment.

The lidar signal processor 200 pre-processes the lidar point data received from the lidar sensor 100 into a processable form and then groups the same in step S100. The pre-processing and clustering portion 210 may perform pre-processing of removing the ground data from the lidar point data, and may group the pre-processed lidar point data into meaningful shape units, that is, point units of parts considered to be the same object.

An object is detected based on clustered points in step S200. The object detector 220 may generate a contour using the clustered points so as to generate and output a shape box according to the shape of the object based on the generated contour.

An object is tracked based on a detected box in step S300. The object tracking portion 230 tracks the object by generating a track box associated with the object based on the shape box.

Tracks, which are results of object tracking, may be classified into specific objects such as pedestrians, guardrails, and cars in step S400 so as to be applied to control a driving function.

For the above object tracking method using a lidar sensor, in this embodiment, information such as shape, location, velocity, heading, etc. of an object obtained by object tracking is extracted, and finally, all information is synthesized to determine whether the object is in a moving state or in a stationary state.

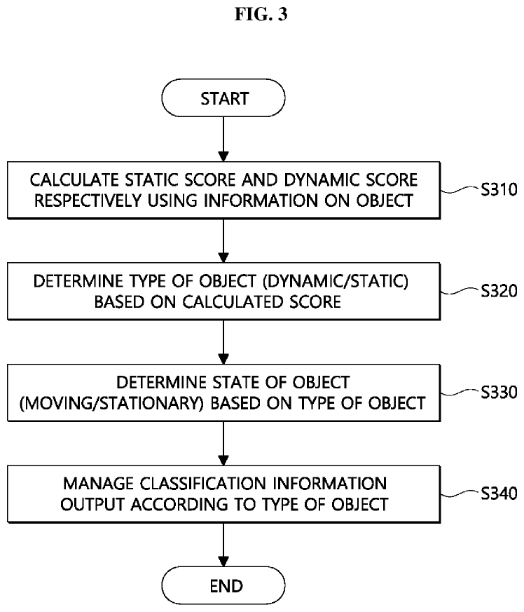

FIG. 3 is a flowchart of a method of determining whether an object is in a moving state or in a stationary state in an embodiment.

Referring to FIG. 3, in order to determine whether an object is in a moving state or in a stationary state, a static score and a dynamic score are calculated using information such as velocity, classification, shape, heading, etc. of the object in step S310. A dynamic score and a static score may be calculated based on a predetermined score table. The score table may include a characteristic item of a static object and a characteristic item of a dynamic object. The following Table 1 exemplifies the items included in the score table.

TABLE 1

| | |
|---|---|
| Static | Classification + Confidence |
| Object | Road Info + Confidence |
| | FoV Object |
| | Gadget |
| | Difference of Area/Heading |
| | Box Size |
| | Feature Info (Guardrail) |
| | High Echo Point |
| | Data Grid Map |
| Dynamic | Road Info + Confidence |
| Object | Shape |
| | Velocity |
| | Difference of Velocity |
| | Age |
| | Classification + Confidence |
| | Class Counter |
| | Part of Car Body |
| | Dynamic Object On Lane |

The object tracking portion 230 may compare the characteristic of a detected object with each item in Table 1 and add a score for the matching characteristics. For example, when the box size of an object is very large, such as a building, or small, such as a rubber cone, or the object has feature information like a guardrail, the characteristic score of the static object is added. When the object has a velocity equal to or greater than a reference velocity or the object is a dynamic object in a lane, the characteristic score of the dynamic object is added. A weight may be added to a score for each item based on its importance. In addition, items in the score table may vary depending on a driving environment such as a highway or an intersection, and may also vary depending on the distance from the object, an occlusion, and the like.

When a static score and a dynamic score for an object are calculated, respectively, according to the score table, it is checked whether the calculated score is equal to or greater than a predetermined reference so as to determine whether a target object is a static object or a dynamic object in step S320. The type of object determined based on the calculated score may be determined to be any one of a static object, a dynamic object, or an unknown object. Here, in the case in which history information on the object exists before determining the type of the object, the type of the object may be finally determined with reference to the history information.

When the type of the object is determined, whether the object is in a moving state or in a stationary state is determined in step S330. A static object and an unknown object may be determined to be in a stationary state. In the case of a dynamic object, whether the dynamic object is in a moving state or a stationary state may be determined by referring to history information.

Based on the determined type of object, the object is classified in step S340.

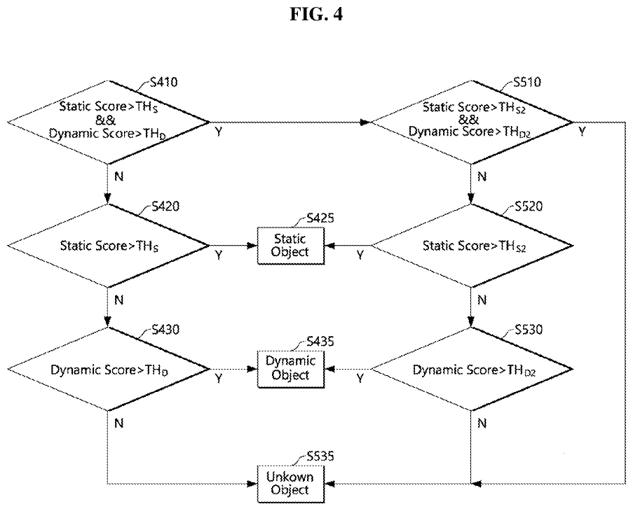

FIG. 4 is a flowchart of a method of determining the type of an object based on a static score and a dynamic score calculated according to the score table in step S320 of FIG. 3.

In order to determine the type of object, a first static object reference value Th_{S} for comparison with a static score, and a second static object reference value Thₛ₂ greater than the first static object reference value Th_{S} may be set. A first dynamic object reference value Th_{D} for comparison with a dynamic score, and a second dynamic object reference value Th_{D2} greater than the first dynamic object reference value Th_{D} may be set. Each of the reference values may vary depending on a driving environment such as a highway or an intersection, and may also vary depending on the distance from an object, an occlusion, and the like.

When a static score and a dynamic score are calculated, respectively, smaller reference values are compared with the calculated score. In other words, it is checked whether the static score is greater than the first static object reference value Th_{S}, and whether the dynamic score is also greater than the first dynamic object reference value Th_{D} in step S410.

When both values are not greater than the first reference values Th_{S} and Th_{D}, whether the static score is greater than the first static object reference value Th_{S} is checked in step S420, and when the static score is greater than the first static object reference value Thₛ, the object is determined to be a static object in step S425.

When the static score is not greater than the first static object reference value Th_{S}, whether the dynamic score is greater than the first dynamic object reference value Th_{D} is checked in step S430, and when the dynamic score is greater than the first dynamic object reference value Th_{D}, the object is determined to be a dynamic object in step S435.

When both the static score and the dynamic score are not greater than the first reference values Th_{S} and Th_{D}, the object is determined to be an unknown object in step S535.

In step S410, when both the static score and the dynamic score are greater than the first reference values Th_{S} and Th_{D}, they are compared with second reference values Th_{S2} and Th_{D2} that are greater than the first reference values Th_{S} and Th_{D}. In other words, it is compared whether the static score is greater than the second static object reference value Th_{S2}, and whether the dynamic score is also greater than the second dynamic object reference value Th_{D2} in step S510.

When both values are not greater than the second reference values Th_{S2} and Th_{D2}, whether the static score is greater than the second static object reference value Th_{S2} is checked in step S520, and when the static score is greater than the second static object reference value Th_{S2}, the object is determined to be a static object in step S425.

When the static score is not greater than the second static object reference value Th_{S2}, whether the dynamic score is greater than the second dynamic object reference value Th_{D2} is checked in step S530, and when the dynamic score is greater than the second dynamic object reference value Th_{D2}, the object is determined to be a dynamic object in step S435.

When both the static score and the dynamic score are not greater than the second reference values Th_{S2} and Th_{D2}, the object is determined to be an unknown object in step S535.

Through the above process, the object may be determined to be any one of a static object, a dynamic object, or an unknown object by using a static score and a dynamic score.

Here, in the case in which history information on the object exists before determining the type of the object, the type of the object may be finally determined with reference to the history information.

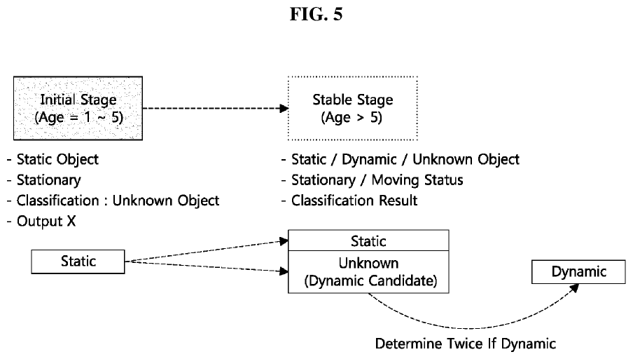

FIG. 5 is a state diagram for explaining a method of finally determining the type of an object by using history information after determining the type of the object based on a score according to the flowchart of FIG. 4.

By comparing an object tracking time (Age) with a reference time, when the Age is less than or equal to the reference time, it may be determined to be an initial stage, and when the Age exceeds the reference time, it may be determined to be a stable stage.

When the reference time is, for example, 5 steps, in the case in which the Age is 5 or less (Age=1 to 5), the state of the object may be determined to be an initial stage.

When the Age is greater than 5 (Age>5), it may be determined to be a stable stage. When the object is determined to be a static object or a dynamic object according to the score, even if the Age is 5 or less (Age=1 to 5), it may move to a stable stage. However, when the Age is 5 or less (Age=1 to 5) and the object is determined to be a dynamic object, the object is determined to be an unknown object yet classified as a dynamic candidate, then it is determined twice whether the object is a dynamic object, and then confirmed to be a dynamic object.

As a result, the object moving to the initial stage may be determined to be an unknown object and also determined to be an object having an Age of 5 or less (Age=1 to 5) based on a score. The determination result in the initial stage is not output, but is processed as a static object and a stationary state by default.

The method of processing the object whose previous state was the initial stage is shown in Table 2 below.

TABLE 2

| | Current | |
|---|---|---|
| Previous | Score | Decide Object |
| Initial Stage | Static | Static Object (Stable) |
| | Dynamic | Unknown Object (Stable) |
| | Unknown | Age <= 5: Static Object |
| | | (Unstable) |
| | | Age > 5: Static Object |
| | | (Stable) |

As shown in Table 2, when a current score of an object that was previously in the initial stage is calculated as a static object, it may be understood that the result determined to be a static object by default in the initial stage has been maintained until the current time point. Therefore, when the current score of the object that was in the initial stage is calculated as a static object, the object may be determined to be a stable static object (Static Object/Stable).

When the current score of the object that was previously in the initial stage is calculated as a dynamic object, it may be understood that the object that has been determined to be a static object by default in the initial stage is determined to be a dynamic object at the current time point. Therefore, when the current score of the object that was in the initial stage is calculated as a static object, the object may be determined to be an unknown object (Unknown Object/Stable).

When the current score of the object that was previously in the initial stage is calculated as an unknown object, it may be understood that the object that has been determined to be a static object by default should be determined to be a static object by default again at the current time point also. For this reason, the object is determined to be a static object. Here, when the tracking time (Age) is 5 or less (Age=1 to 5), the object may be determined to be an unstable static object (Static Object/Unstable), and when the Age is greater than 5 (Age >5), the object may be determined to be a stable static object (Static Object/Stable).

The method of processing the object whose type was determined is shown in Table 3 below.

TABLE 3

| Previous | Current | Final Object |
|---|---|---|
| Static | Static/ | Static Object |
| | Unknown | |
| | Dynamic | Static Object (Opposite cnt++) |
| | | Opposite Cnt > th: Unknown Object (Reset, |
| | | stationary) |
| Dynamic | Static | Dynamic Object (Opposite cnt++) |
| | | Opposite Cnt > th: Ghost |
| | Dynamic/ | Dynamic Object |
| | Unknown | |
| Unknown | Dynamic | Determine twice if Dynamic→ Dynamic Object |
| (Dynamic | Static/ | Unknown Object (stationary) |
| Candidate) | Unknown | |

As shown in Table 3, even if an object has been previously classified as Static Object, Dynamic Object, Unknown Object, or Unknown/Dynamic Candidate, the accuracy of determining whether the object is a dynamic object or a static object may be increased by comparing the current determination result with the previous determination result to finally determine the type of the object.

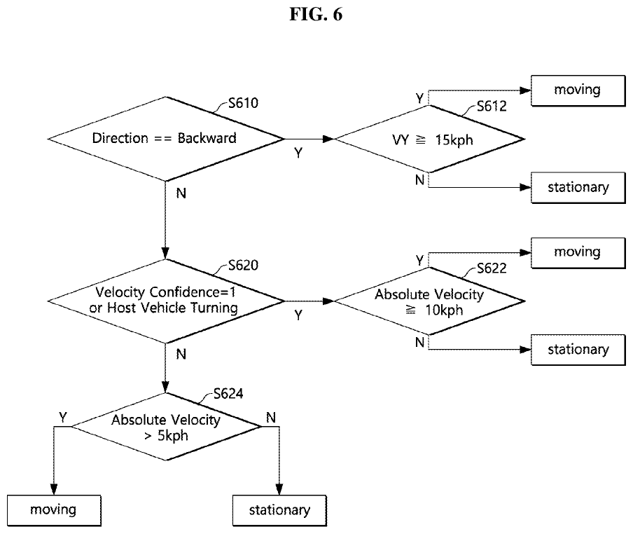

FIG. 6 is a flowchart of a method of determining the state of an object in step S320 of FIG. 3. When the type of the object is determined, whether the object is in a moving state or in a stationary state is determined.

When the type of the object is determined to be a static object (Static Object) or an unknown object (Unknown), the object may be determined to be in a stationary state.

When the type of the object is a dynamic object, it may be possible to finally determine whether the object is in a moving state or a stationary state based on history information. One piece of history information is managed in such a way that five frames are stored in five stacks. Accordingly, based on the movement information of the corresponding object included in the previous five frames, it may be possible to finally determine whether the object is in a moving state or a stationary state.

Referring to FIG. 6, whether the object is moving backwards is determined in step S610. When it is determined that the object is moving backwards, the relative velocity of the object is compared with the reference velocity (e.g., 15 kph) in step S612. Here, when the relative velocity is greater than or equal to the reference velocity, the object is determined to be in a moving state, and when the relative velocity is smaller than the reference velocity, the object is determined to be in a stationary state.

When the moving direction of the object is not backwards, whether the reliability of the velocity is low or the host vehicle is turning is determined in step S620.

When the reliability of the velocity is low (e.g., equals 1) or the host vehicle is turning, the absolute velocity of the object is compared with the reference velocity, for example, 10 kph, in step S622. Here, when the absolute velocity is greater than or equal to the reference velocity, the object is determined to be in a moving state, and when the absolute velocity is less than the reference velocity, the object is determined to be in a stationary state.

When the reliability of the velocity is guaranteed or the host vehicle is not turning, the absolute velocity of the object is compared with the reference velocity, for example, 5 kph, in step S624. Here, when the absolute velocity is greater than or equal to the reference velocity, the object is determined to be in a moving state, and when the absolute velocity is less than the reference velocity, the object is determined to be in a stationary state.

According to the above process, when the type and state of the object are determined, classification information (Class Info) output according to the type of the object is updated.

Classification information commonly used is as follows.

Default
Unknown Vehicle
PV (Passenger Vehicle)
CV (Commercial Vehicle)
Pedestrian
PTW
Road Edge
Unknown Object

The following Table 4 exemplifies a method of updating classification information according to an embodiment.

TABLE 4

| Object | Output Class | | Object Class |
|---|---|---|---|
| Static Static Static | Default UK_V PV | [symbol] | UK_O UK_O UK_O |
| Static | CV | | UK_O |
| Static | Ped | | UK_O |
| Static | PTW | | UK_O |
| Static | RE | | RE |
| Static | UK_O | | UK_O |
| Dynamic/UK_O | Default | | UK_V |
| Dynamic/UK_O | UK_V | | UK_V |
| Dynamic/UK_O | PV | | PV/CV |
| Dynamic/UK_O | CV | | CV |
| Dynamic/UK_O | Ped | | Ped/UK_V |
| Dynamic/UK_O | PTW | | PTW/UK_V |
| Dynamic/UK_O | RE | | UK_V |
| Dynamic/UK_O | UK_O | | UK_V |

As shown in Table 4, the classifications are used as they are, but vary according to dynamic/static objects.

In the case of a static object, the road edge (RE) is classified as a road edge (RE) as it is, and other objects are simplified and classified as unknown UK_O.

In the case of a dynamic object or an unknown object, RE and UK_O are classified as UK_V. However, for other objects, the classifications are applied as they are.

As described above, in this embodiment, when the shape, location, velocity, heading, etc. of the lidar object are selected, the type of object is determined based on the dynamic score and the static score calculated according to the predetermined score table, and for the object determined to be a dynamic object, whether the object is in a moving state or in a stationary state may be determined using history information.

The score table (Table 1) proposed in this embodiment includes a characteristic item of a static object and a characteristic item of a dynamic object, and may reflect the characteristics of the static/dynamic objects obtained by observation or experimentally.

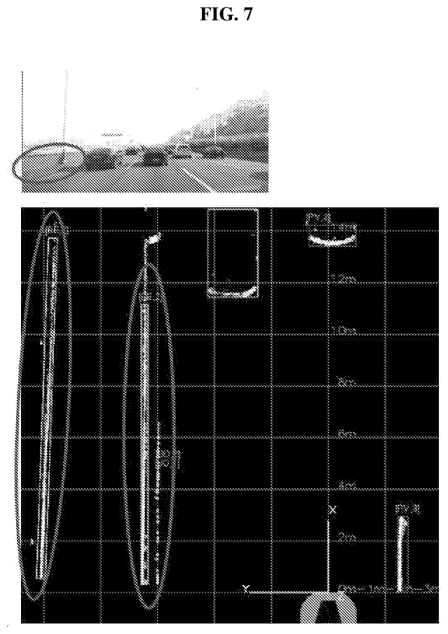

FIGS. 7 to 21 are diagrams for explaining each item included in the score table of Table 1.

FIG. 7 is a diagram for explaining a method of adding a static score using classification. The static score may be added according to the classification of the object tracking portion 230. When classified as the road edge (RE) as shown in FIG. 7, a static score may be added.

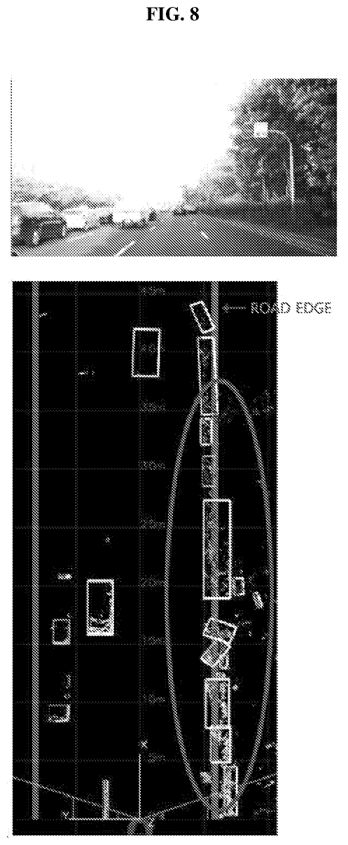

FIG. 8 is a diagram for explaining a method of adding a static score using road information (Road Info). When road information on the road edge is provided as shown in FIG. 8, a static score may be added to an object present outside the road edge.

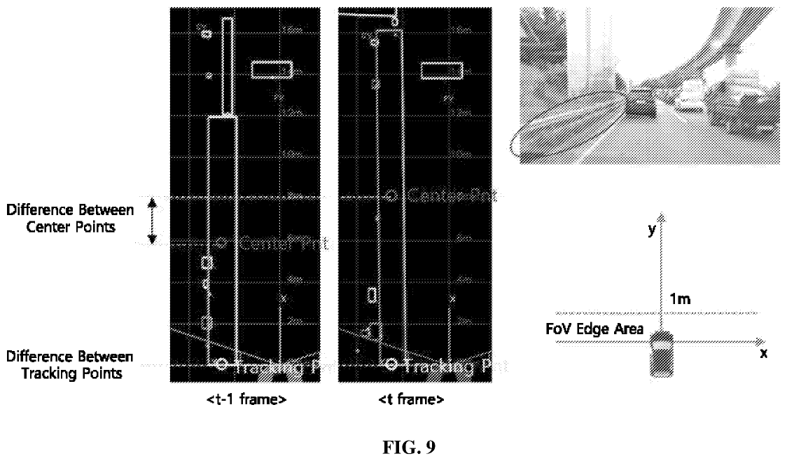

FIG. 9 is a view for explaining a method of determining a static object at the edge of a field of view (FoV). For a static object located on the edge of the FoV, when comparing the difference between the tracking point of the previous frame (t−1 frame) and the tracking point of the current frame (t frame) with the difference between the center point of the previous frame (t−1 frame) and the center point of the current frame (t frame), the difference between the tracking points is larger than the difference between the center points. Therefore, in the object located at the edge of the FoV, when the difference between the center points between frames is greater than the difference between the tracking points, a static score may be added.

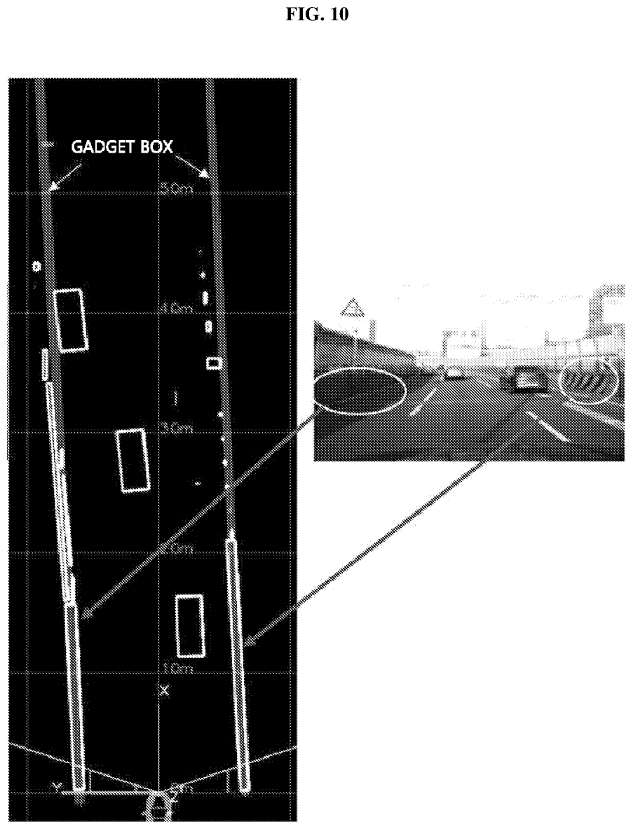

FIG. 10 is a diagram for explaining a method of adding a static score using a gadget. When there is a static object with high reliability in the FoV, it may be possible to create an elongated gadget box while maintaining the heading of the corresponding object. A static score may be added to an object that is present outside the gadget box.

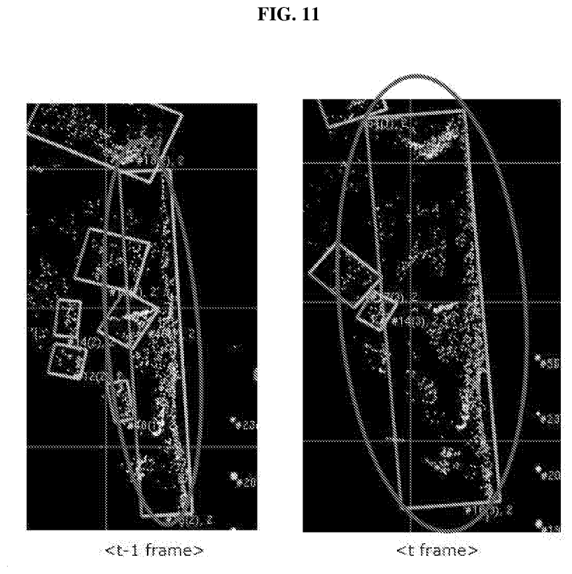

FIG. 11 is a diagram for explaining a method of adding a static score using an area and a heading of the object. In the case of a static object, when the area and heading of the previous frame (t−1 frame) and the area and heading of the current frame (t frame) are compared, the difference is large. Therefore, for an object in which the difference between the area and heading of the previous frame (t−1 frame) and the area and heading of the current frame (t frame) is greater than or equal to a reference, a static score may be added.

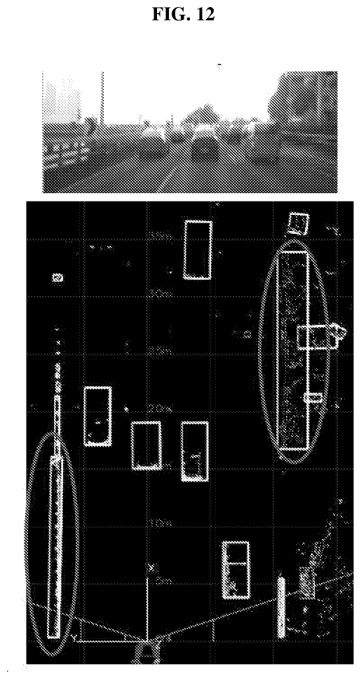

FIG. 12 is a diagram for explaining a method of adding a static score using the box size of an object. A dynamic object includes a passenger vehicle, a commercial vehicle, a pedestrian, a motorcycle, and the like. In comparison, when the box size of the object is larger than the reference, a static score may be added.

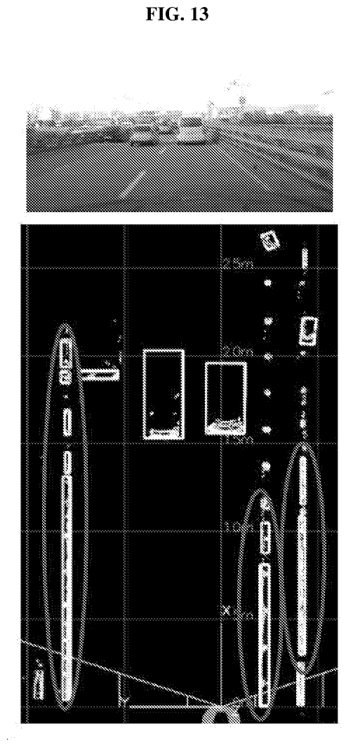

FIG. 13 is a diagram for explaining a method of adding a static score using a guardrail feature. For an object having characteristics of guardrails, such as an object having a narrow width, which is smaller than the reference, a predetermined height, and a long length, a static score may be added.

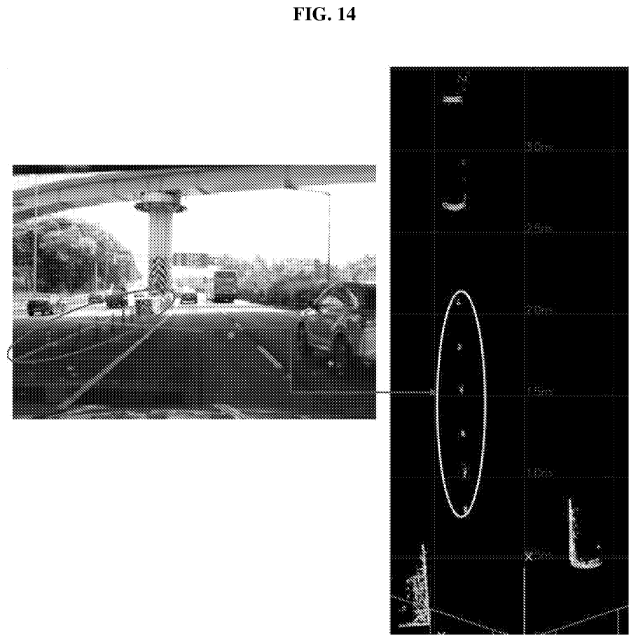

FIG. 14 is a diagram for explaining a method of adding a static score using a high echo point. In the case of an object to which a reflector is attached or having high reflectivity, such as a rubber cone, a street lamp, a traffic sign, a concrete barrier, a center divider, etc., a static score may be added.

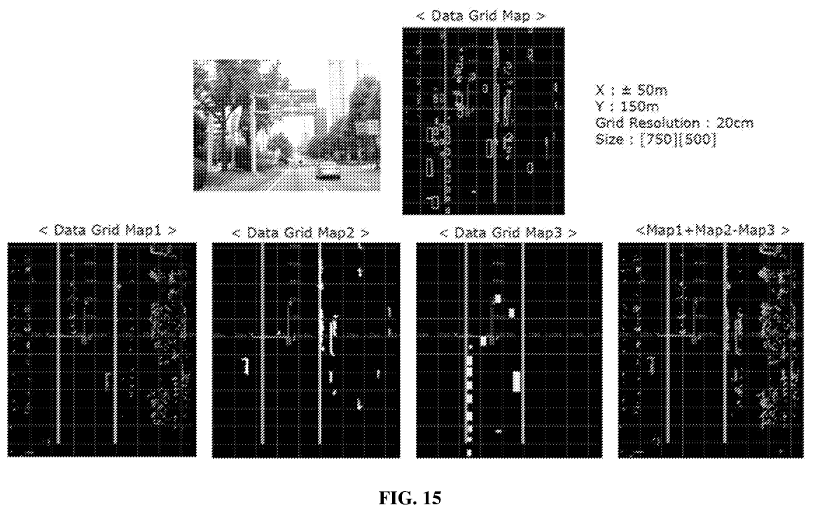

FIG. 15 is a diagram for explaining a method of adding a static score using a grid map.

[ono] Data Grid Map 1 is a map created using points that are at the height of 3 to 4.5 m. Accordingly, Data Grid Map 1 may include points obtained from road traffic signs, traffic lights, and the like. Data Grid Map 2 is a map created using points of objects determined to be static objects. Data Grid Map 3 is a map created using box information of objects determined to be dynamic objects. Information of Data Grid Map 1 and information of Data Grid Map 2 are combined and data of Data Grid Map 3 is excluded so as to generate a final Data Grid Map. Accordingly, only the points at the height of 3 m to 4.5 m and the points of the static objects remain in the final Data Grid Map. A static score may be added to the objects recognized in the final Data Grid Map.

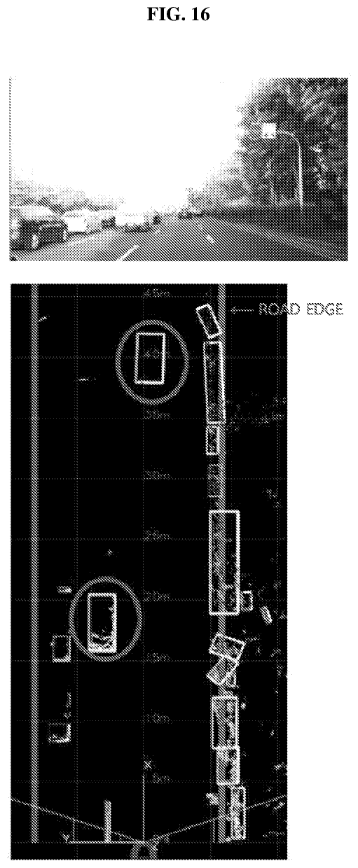

FIG. 16 is a diagram for explaining a method of adding a dynamic score using road information (Road Info). When road information on the road edge is provided as shown in FIG. 16, a dynamic score may be added to an object present within the road edge.

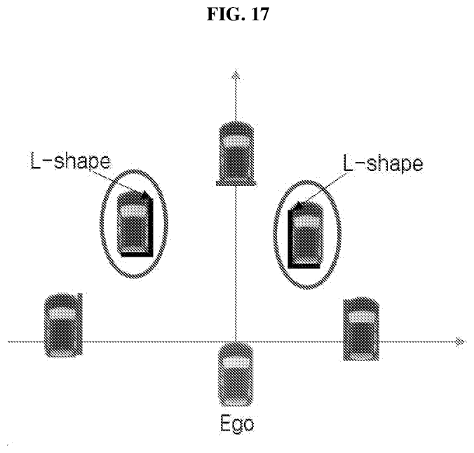

FIG. 17 is a diagram for explaining a method of adding a dynamic score using shape information of the object. In the case of a vehicle, an L-shape is clearly recognized. Therefore, while recognizing an object, a dynamic score may be added to an object having an L-shape.

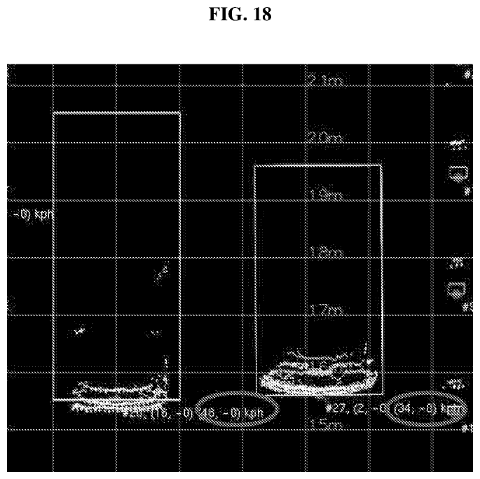

FIG. 18 is a diagram for explaining a method of adding a dynamic score using velocity, a difference in velocity, and Age. Objects in FIG. 18 have velocities of 48 kph and 34 kph, respectively. Generally, the velocity value measured from a dynamic object (car, commercial vehicle, pedestrian, motorcycle, etc.) is limited. Therefore, a dynamic score may be added using an absolute velocity or dependency according to the moving direction of the dynamic object.

In addition, when comparing the velocity of the dynamic object with the velocity of the previous frame, the dynamic object has a small velocity difference. Therefore, when the velocity difference from the previous frame is small, a dynamic score may be added.

For a static object such as a bush, object id may not be maintained for a long time due to shape change, whereas for a dynamic object, object id may be maintained for a long time. Therefore, when Age is large, a dynamic score may be added.

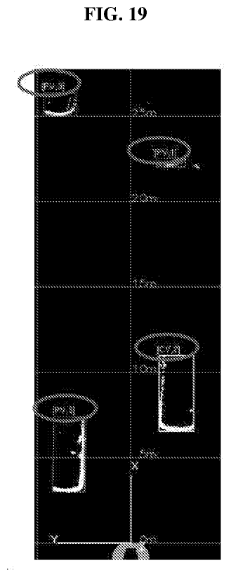

FIG. 19 is a diagram for explaining a method of adding a dynamic score using classification and a class counter.

When the object tracking portion 230 classifies an object into a dynamic object such as a passenger vehicle (PV), a commercial vehicle (CV), a pedestrian (PED), and PTW (Powered Tow Wheeler), a dynamic score may be added. In addition, when objects are consecutively classified as dynamic objects such as PV, CV, PED, and PTW, a count is given, and when the count is high, a dynamic score may be added. FIG. 19 shows an object recognition result to which a PV count and a CV count are added, respectively.

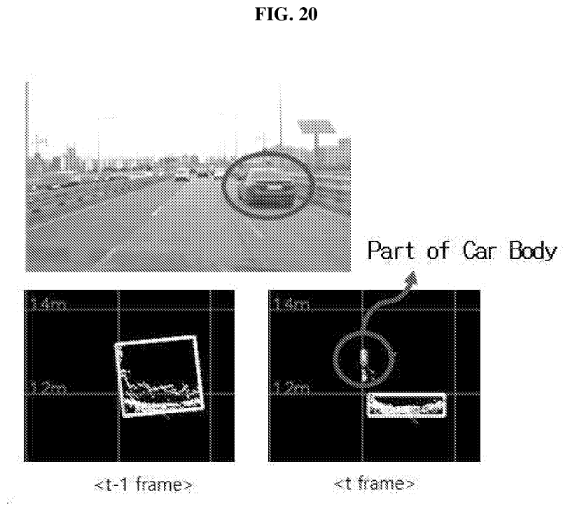

FIG. 20 is a diagram for explaining a method of adding a dynamic score when a part of a car body is recognized. As shown in FIG. 20, when a part of a car body is recognized among frames, a dynamic score may be added.

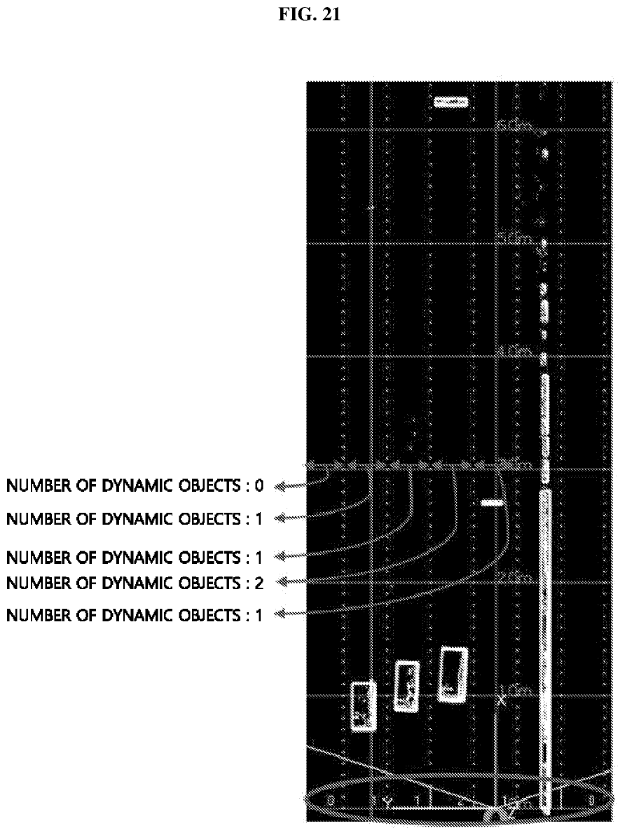

FIG. 21 is a diagram for explaining a method of adding a dynamic score according to the number of dynamic objects in a lane. The number of dynamic objects is counted for each lane, and when the counted number is large, a dynamic score may be added.

As described above, in this embodiment, when the shape, location, velocity, heading, etc. of the lidar object are selected, the type of object is determined based on the dynamic score and the static score calculated according to the predetermined score table, and for the object determined to be a dynamic object, whether the object is in a moving state or in a stationary state may be determined using history information. Therefore, it may be possible to determine whether the lidar object is in a moving state or in a stationary state with an uncomplicated structure, and even if an issue occurs, it may be simply debugged and modified.

An object tracking device using a lidar sensor and a method of determining moving and stationary states of an object according to an embodiment may determine whether a lidar object is in a moving state or in a stationary state with an uncomplicated structure, and may easily modify conditions for determining the moving or stationary states of the object.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of determining moving and stationary states of an object using a lidar sensor, the method comprising:
determining a type of object after assigning a score to object information obtained through object tracking, the score based on a score table in which scores are set according to characteristics of a dynamic object and a static object; and
determining that the object is in a stationary state when the object is determined to be a static object, and determining whether the object is in a moving state or in the stationary state based on object tracking information on the object when the object is determined to be a dynamic object.

2. The method according to claim 1, wherein the object information comprises velocity information, shape information, heading information, or classification information of the object.

3. The method according to claim 1, wherein the score table comprises an item to assign a dynamic score and an item to assign a static score.

4. The method according to claim 3, wherein determining the type of object comprises:
comparing the dynamic score and the static score given according to the score table with a first reference value set for the dynamic score and the static score, respectively;
determining the type of object as the dynamic object or the static object based on either the dynamic score or the static score of the object being greater than the first reference value; and
determining the type of object as an unknown object when both the dynamic score and the static score are smaller than the first reference value.

5. The method according to claim 4, wherein determining the type of object comprises:
when both the dynamic score and the static score are greater than the first reference value, comparing the dynamic score and the static score given according to the score table with a second reference value greater than the first reference value;
determining the type of object as the dynamic object or the static object based on either the dynamic score or the static score being greater than the second reference value;
determining the type of object as the unknown object when both the dynamic score and the static score are smaller than the second reference value; and
determining the type of object as the unknown object when both the dynamic score and the static score are greater than the second reference value.

6. The method according to claim 5, further comprising, when the type of object is determined to be the dynamic object, confirming the determination after repeating determining the type of object according to the dynamic score and the static score a plurality of times.

7. The method according to claim 5, further comprising:
when an object tracking time is less than or equal to a reference time, treating the object determined to be the unknown object as the static object; and
when the object tracking time is greater than the reference time, maintaining the determination of the object as the unknown object.

8. The method according to claim 5, further comprising determining the type of object after comparing the type of object determined at a current time point with the type of object determined at a previous time point.

9. A non-transitory computer-readable recording medium on which a program configured to implement a method of determining moving and stationary states of an object using a lidar sensor is recorded, wherein the program, when executed by a processor, causes the processor to:
determine a type of object after assigning a score to object information obtained through object tracking, the score based on a score table in which scores are set according to characteristics of a dynamic object and a static object; and
determine that the object is in a stationary state when the object is determined to be a static object, and determine whether the object is in a moving state or in the stationary state based on object tracking information on the object when the object is determined to be a dynamic object.

10. The medium according to claim 9, wherein the object information comprises velocity information, shape information, heading information, or classification information of the object.

11. The medium according to claim 9, wherein the score table comprises an item to assign a dynamic score and an item to assign a static score.

12. The medium according to claim 11, wherein the type of object is determined by:
comparing the dynamic score and the static score given according to the score table with first reference values set for the dynamic score and the static score, respectively;
determining the type of object as the dynamic object or the static object based on either the dynamic score or the static score of the object being greater than the first reference value; and
determining the type of object as an unknown object when both the dynamic score and the static score are smaller than the first reference value.

13. An object tracking device, the device comprising:
a lidar sensor; and
a lidar signal processor configured to:
track an object using lidar data obtained by the lidar sensor,
determine a type of object after assigning a score to object information obtained through object tracking, the score based on a score table in which scores are set according to characteristics of a dynamic object and a static object,
determine that the object is in a stationary state when the object is determined to be a static object, and
determine whether the object is in a moving state or in the stationary state based on object tracking information on the object when the object is determined to be a dynamic object.

14. The device according to claim 13, wherein the object information comprises velocity information, shape information, heading information, or classification information of the object.

15. The device according to claim 13, wherein the score table comprises an item to assign a dynamic score and an item to assign a static score.

16. The device according to claim 15, wherein the lidar signal processor is configured to compare the dynamic score and the static score given according to the score table with a first reference value set for the dynamic score and the static score, respectively, determine the type of object as the dynamic object or the static object based on either the dynamic score or the static score of the object being greater than the first reference value, and determine the type of object as an unknown object when both the dynamic score and the static score are smaller than the first reference value.

17. The device according to claim 16, wherein the lidar signal processor is configured to, when both the dynamic score and the static score are greater than the first reference value, compare the dynamic score and the static score given according to the score table with a second reference value greater than the first reference value, determine the type of object as the dynamic object or the static object based on either the dynamic score or the static score being greater than the second reference value, determine the type of object as the unknown object when both the dynamic score and the static score are smaller than the second reference value, and determine the type of object as the unknown object when both the dynamic score and the static score are greater than the second reference value.

18. The device according to claim 17, wherein the lidar signal processor is configured to, when the object is determined to be the dynamic object, confirm the determination after repeating determining the type of object according to the dynamic score and the static score a plurality of times.

19. The device according to claim 17, wherein the lidar signal processor is configured to, when an object tracking time is less than or equal to a reference time, treat the object determined to be the unknown object as the static object, and, when the object tracking time is greater than the reference time, maintain the determination in which the object is determined to be the unknown object.

20. The device according to claim 17, wherein the lidar signal processor is configured to compare the type of object determined at a current time point with the type of object determined at a previous time point so as to determine the type of object.
